(19) United States
(12) Patent Application Publication
(10) Pub. No.: US 2025/0326094 A1
(43) Pub. Date: Oct. 23, 2025

(54) TOOL BIT CONNECTION SHAFT STRUCTURE FOR ELECTRIC SCREWDRIVER AND ELECTRIC SCREWDRIVER

(71) Applicants: Xiaofeng ZHANG, Zhenjiang (CN); DANYANG JIANLU TOOLS CO., LTD., Zhenjiang (CN)

(72) Inventors: Xiaofeng ZHANG, Zhenjiang (CN); Ning JIANG, Zhenjiang (CN); Yuan ZHANG, Zhenjiang (CN); Youming JIANG, Zhenjiang (CN)

(73) Assignees: Xiaofeng ZHANG, Zhenjiang (CN); DANYANG JIANLU TOOLS CO., LTD., Zhenjiang (CN)

(21) Appl. No.: 18/973,190

(22) Filed: Dec. 9, 2024

(30) Foreign Application Priority Data
Apr. 23, 2024 (CN) 202410491546.5

(51) Int. Cl. B25B 23/00; B25B 21/00; B25B 23/12

(52) U.S. Cl. CPC B25B 23/0035; B25B 21/00; B25B 23/12

(57) ABSTRACT

A tool bit connection shaft structure for an electric screwdriver and an electric screwdriver is provided, which includes a power output shaft front section and a shaft end sleeve in cooperation with the power output shaft front section. A magnet and a bit connecting hole are provided in the shaft end sleeve. The power output shaft front section, the magnet, and the bit connecting hole are sequentially arranged in an axial direction of the shaft end sleeve. The shaft end sleeve is made of a non-magnetically conductive material. The power output shaft front section is made of a magnetically conductive material, and an end surface of the power output shaft front section and the magnet are in contact with each other.

### CROSS-REFERENCE TO RELATED APPLICATIONS

This application claims priority to Chinese Application No. 202410491546.5, having a filing date of Apr. 23, 2024, the entire contents of which are hereby incorporated by reference.

### TECHNICAL FIELD

The present invention belongs to the field of electric tool and accessory technologies, and relates to a tool bit connection shaft structure for an electric screwdriver and an electric screwdriver.

### BACKGROUND OF THE INVENTION

In an electric screwdriver in the prior art, a magnet is usually used to attract a bit and a screw, and when a bit with a magnet is used to connect to a shaft end, the magnetism of the bit mainly comes from a magnet disposed in a connection shaft at which the bit is mounted. To increase a magnetic attraction force of a magnet disposed inside an output shaft end and also to provide a sufficiently strong magnetic force at a distal end of a long bit, it is necessary to maximize the magnetic attraction force of the magnet disposed inside the shaft end. However, as a result, to replace the bit, a large force is required to separate the bit from the connected shaft end. For many common bits, because an exposed part is small and short, the shapes of many models make it impossible to pinch and pull out such bits. Therefore, when a tool bit is tightly attracted by a magnetic force, it may even be necessary to use pliers or another tool to separate the bit from the electric screwdriver.

The use of the foregoing manner of only increasing the magnetism of a magnet to improve a screw supporting effect inevitably brings about certain negative effects. To be specific, when a long bit is used, because a screw is relatively far away from a magnet, magnetic force performance of a tip portion of the bit is greatly reduced, or even there seems to be no presence of a magnetic attraction force. In addition, the use of a manner of only increasing the area and thickness of an embedded magnet to increase a magnetic attraction force of a tip portion of a bit is also limited. To be specific, due to limitations in the size of a machine as well as upper limits in the magnetic force and the size of a magnet, it is impossible to optimally achieve a magnetic force strength required by a user, especially when a long and thin tool bit is used. Currently, none of the common commercially available electric screwdrivers can optimally converge a magnetic force at a tip portion of a tool bit, and a magnetic force is far from enough to attract and erect a screw.

In the prior art, it is quite a compromise to arrange an annular magnet outside (near a screw) an end opening of an output shaft, or simply add a magnetic sleeve outside a bit to increase a magnetic force of a tip portion of the bit. However, both manners are not ideal in terms of costs and convenience.

In view of the foregoing reasons, there is in the market an urgent need for an electric screwdriver that can allow convenient insertion and removal of bits with small sizes and small specifications and can also make a magnetic force of a tip portion of a bit strong enough to achieve optimal effects of screw attraction and screw supporting, so that in a case that operations are performed with a single hand and a machine is turned on to rotate, a screw is kept from falling off and is attracted upright at the tip portion of the bit, especially a tip portion of a long and thin bit.

### SUMMARY OF THE INVENTION

To resolve the deficiencies in the prior art, an objective of the present invention is to provide a tool bit connection shaft structure for an electric screwdriver and an electric screwdriver.

To achieve the foregoing objective, the following technical solution is adopted in the present invention.

A tool bit connection shaft structure for an electric screwdriver includes a power output shaft front section and a shaft end sleeve in cooperation with the power output shaft front section, where a magnet and a bit connecting hole are provided in the shaft end sleeve, and the power output shaft front section, the magnet, and the bit connecting hole are sequentially arranged in an axial direction of the shaft end sleeve; and the shaft end sleeve is made of a non-magnetically conductive material.

Preferably, for the foregoing tool bit connection shaft structure for an electric screwdriver, the power output shaft front section is made of a magnetically conductive material, and an end surface of the power output shaft front section and the magnet are in contact with each other.

Preferably, for the foregoing tool bit connection shaft structure for an electric screwdriver, a single-surface end surface area of the magnet is not greater than an area of a shaft end of the power output shaft front section in contact with the magnet.

Preferably, for the foregoing tool bit connection shaft structure for an electric screwdriver, a radial cross-section of the power output shaft front section is a regular polygon, a radial cross-section of the magnet is a circle, and an opposite-side size of the regular polygon is not less than a diameter of the magnet.

Preferably, for the foregoing tool bit connection shaft structure for an electric screwdriver, a magnetic force adjustment structure is further disposed at a bit connecting end of the magnet, and the magnetic force adjustment structure is one of a gasket, a ring, or a combined structure of the gasket and the ring.

Preferably, for the foregoing tool bit connection shaft structure for an electric screwdriver, when the magnetic force adjustment structure is a ring, the ring is a ring with an inner bevel, a right-angle ring or a ring with a cross-section being a circle, and the inner bevel is in contact with a chamfer at a tail portion of a connected bit.

Preferably, for the foregoing tool bit connection shaft structure for an electric screwdriver, when the magnetic force adjustment structure is a combined structure of the gasket and the ring, the gasket and the ring have an integrated structure with equal outer diameters or a concentric stack structure of the gasket and the ring with equal outer diameters, and the gasket is placed between the magnet and the ring.

Preferably, for the foregoing tool bit connection shaft structure for an electric screwdriver, when the magnetic force adjustment structure is a ring, the ring is a C-shaped ring or a closed ring structure.

Preferably, for the foregoing tool bit connection shaft structure for an electric screwdriver, when the magnetic force adjustment structure is a closed ring structure, the closed ring structure matches the chamfer at the tail portion of the bit, and the chamfer of the bit is one of an inclined-plane chamfer or a right-angled chamfer.

Preferably, for the foregoing tool bit connection shaft structure for an electric screwdriver, a C-shaped ring is further disposed at a bit connecting end of the magnet, and an arc-shaped chamfer, a trapezoidal chamfer or a right-angled chamfer matching the C-shaped ring is disposed at a tail portion of a bit.

Preferably, for the foregoing tool bit connection shaft structure for an electric screwdriver, the power output shaft front section is transmission-connected to a motor body by a power output shaft rear section and a speed change gearbox sequentially, and the power output shaft front section and the power output shaft rear section have a split structure or an integrated structure.

Preferably, for the foregoing tool bit connection shaft structure for an electric screwdriver, a connecting sheet made of a magnetically conductive material is further disposed between the shaft end of the power output shaft front section and the magnet.

Preferably, for the foregoing tool bit connection shaft structure for an electric screwdriver, the shaft end sleeve is connected to the C-shaped ring by an inner annular groove.

Preferably, for the foregoing tool bit connection shaft structure for an electric screwdriver, a power output shaft rear section and the shaft end sleeve have an integrated structure and a non-magnetically conductive structure, a magnetic guiding block in contact with the magnet is disposed in the integrated structure, and the magnetic guiding block is made of a magnetically conductive material.

An electric screwdriver includes the foregoing tool bit connection shaft structure for an electric screwdriver.

Beneficial effects achieved by the present invention:

Compared with the prior art, in the present invention, a disadvantage that originally an output shaft end of an electric screwdriver is generally processed by using a magnetically conductive material being iron is changed, a manner of combining an outer sleeve made of a non-magnetically conductive material and an output shaft section made of a magnetically conductive material is used, and a magnetic guiding block is disposed at a rear portion of a magnet, to increase a quantity of magnetic lines of force that converge at a tip portion at a distal end of a bit, thereby reducing magnetic leakage, and improving a magnetic force of the tip portion of the bit.

In the present invention, the magnetic force adjustment structure may be further added between the magnet and a tool bit, so that while it is ensured that a magnetic circuit is unimpeded and a magnetic force at a tip portion of a bit is sufficient, a direct attraction force of the magnet on a conventional ordinary tool bit, especially a tool bit with a small specification, is reduced to a degree that allows comfortable insertion and removal by a user.

An original internal structure of a shaft end is changed, and a spring structure for mechanical clamping is added based on an original function of magnetically attracting a bit, so that some tool bits that require more secure clamping, for example, a hex shank drill bit, can be fastened doubly.

### BRIEF DESCRIPTION OF DRAWINGS

FIG. 1 is an external structural diagram of an electric screwdriver according to the present invention;

FIG. 2 is an axial cross-sectional view of a tool bit connection shaft structure for an electric screwdriver according to the present invention;

FIG. 3 is a cross-sectional view of a tool bit connection shaft structure for an electric screwdriver according to the present invention (a gasket and a ring with an inner bevel have an integrated structure);

FIG. 4 is a cross-sectional view 1 of a shaft end sleeve according to the present invention (a magnetic force adjustment structure is a ring with a cross-section being a circle);

FIG. 5 is a cross-sectional view 2 of a shaft end sleeve according to the present invention (a concealed magnet and a magnetic force adjustment structure);

FIG. 6 is a cross-sectional view 3 of a shaft end sleeve according to the present invention (a right-angle ring and a connecting sheet are respectively provided on two sides of a magnet);

FIG. 7 is a cross-sectional view 5 of a shaft end sleeve according to the present invention (a power output shaft rear section and a shaft end sleeve have an integrated structure);

FIG. 8 is a schematic diagram of a distribution of magnetic field lines of a tool bit connection shaft structure according to the present invention;

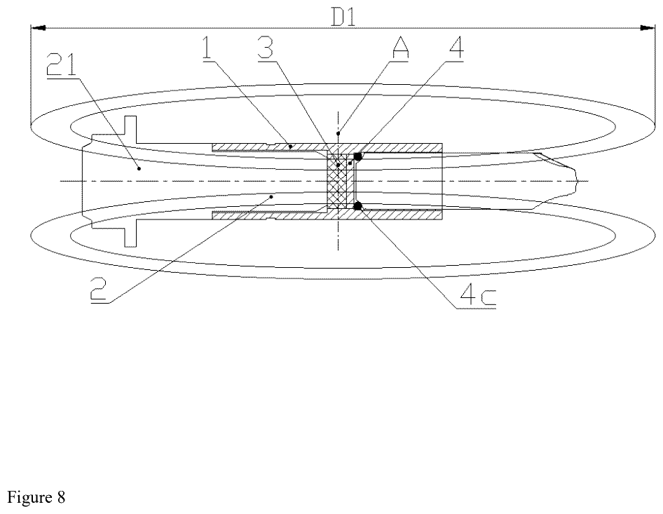

FIG. 9 is a cross-sectional view 1 of a ring with a cross-section being a circle and a tail portion of a bit according to the present invention (a tail portion of a bit is an arc-shaped chamfer);

FIG. 10 is a cross-sectional view 2 of a ring with a cross-section being a circle and a tail portion of a bit according to the present invention (a tail portion of a bit is an inverted trapezoidal chamfer);

FIG. 11 is a cross-sectional view 3 of a ring with a cross-section being a circle and a tail portion of a bit according to the present invention (a tail portion of a bit is a right-angled chamfer); and

FIG. 12 is a schematic diagram of a distribution of magnetic field lines inside a tool bit connection shaft structure according to the present invention.

Meanings of reference numerals in the drawings: 1—shaft end sleeve; 2—power output shaft front section; 3—magnet; 4—gasket; 5—C-shaped ring; 11—bit connecting hole; 21—power output shaft rear section; 12—inner annular groove; 6—connecting sheet; 4a—ring with an inner bevel; 4b—right-angle ring; 4c—ring with a cross-section being a circle; and 7—magnetic guiding block.

### DETAILED DESCRIPTION OF THE INVENTION

The following further describes the present invention in detail with reference to the accompanying drawings. The following embodiments are only used for describing the technical solutions of the present invention more clearly, but cannot be used to limit the scope of protection of the present invention.

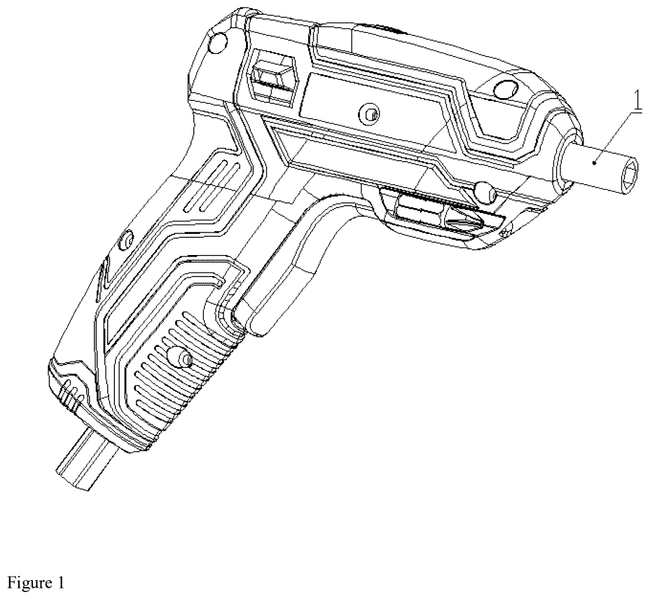

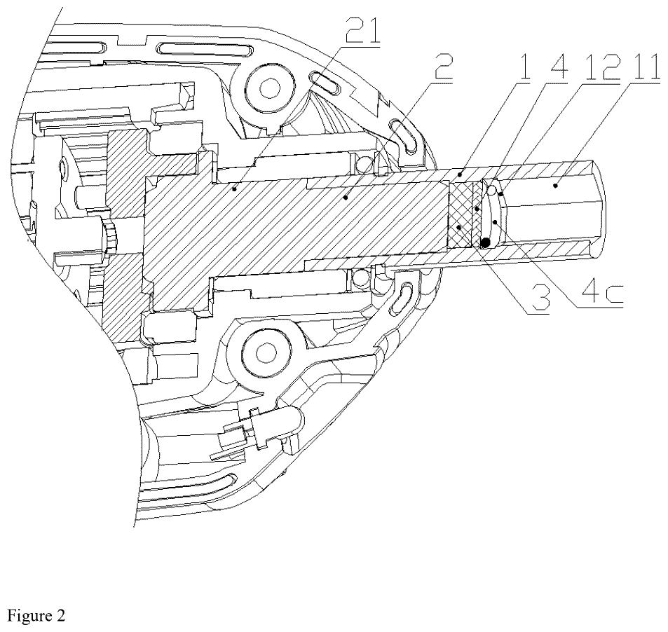

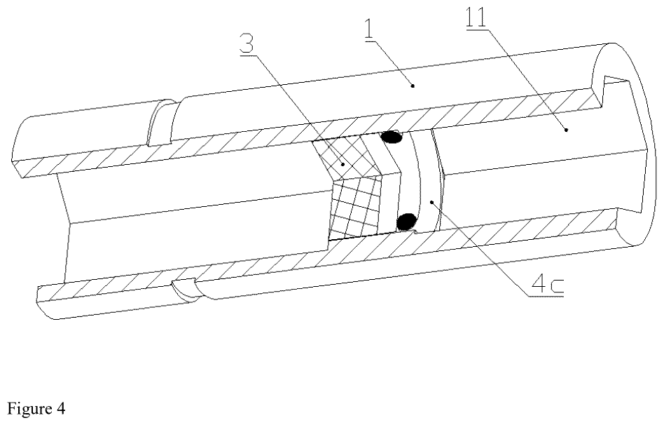

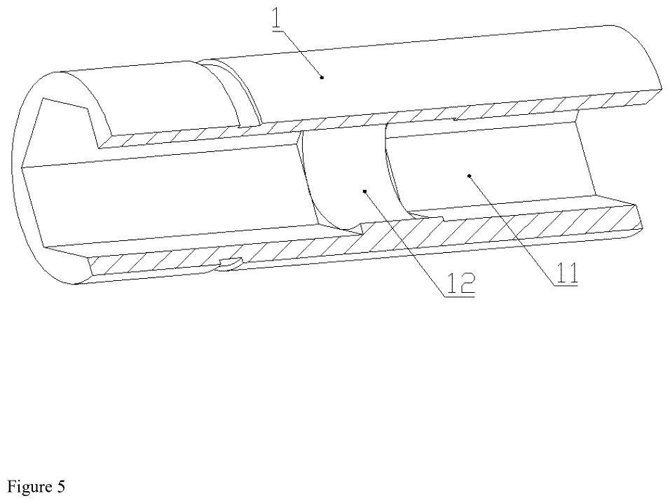

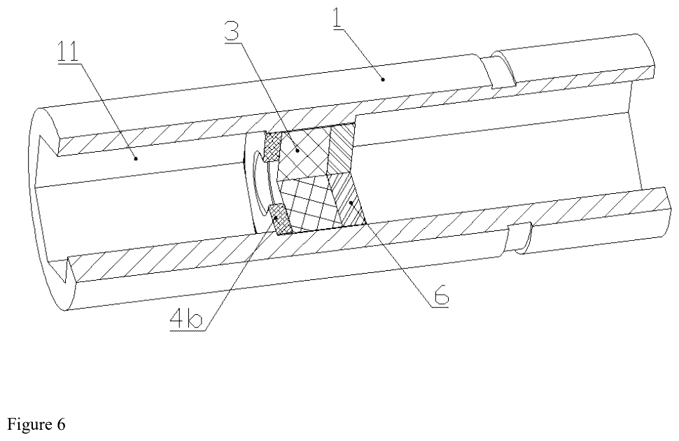

As shown in FIG. 1 to FIG. 7, this embodiment discloses a tool bit connection shaft structure for an electric screwdriver, including a power output shaft front section 2 and a shaft end sleeve 1 in cooperation with the power output shaft front section 2. A magnet 3 and a bit connecting hole 11 are provided in the shaft end sleeve 1, and the power output shaft front section 2, the magnet 3, and the bit connecting hole 11 are sequentially arranged in an axial direction of the shaft end sleeve 1. The shaft end sleeve 1 is made of a non-magnetically conductive material, and is configured for avoiding interference with a magnetic field emitted by the magnet 3. The power output shaft front section 2 is made of a magnetically conductive material, and an end portion of the power output shaft front section 2 and the magnet 3 are in contact with each other. A direct contact between the magnet 3 and a shaft end surface of the power output shaft front section 2 is in a relatively ideal state. Alternatively, a thin iron sheet is provided between the magnet 3 and the shaft end surface of the power output shaft front section 2 to transfer magnetic lines of force, and is in fact equivalent to being in contact, which also belongs to the scope of protection of the present invention. The magnet 3 in this embodiment generally has a cylindrical shape, and magnetization surfaces of the magnet 3 are two end portions, i.e., the magnet 3 is axially magnetized.

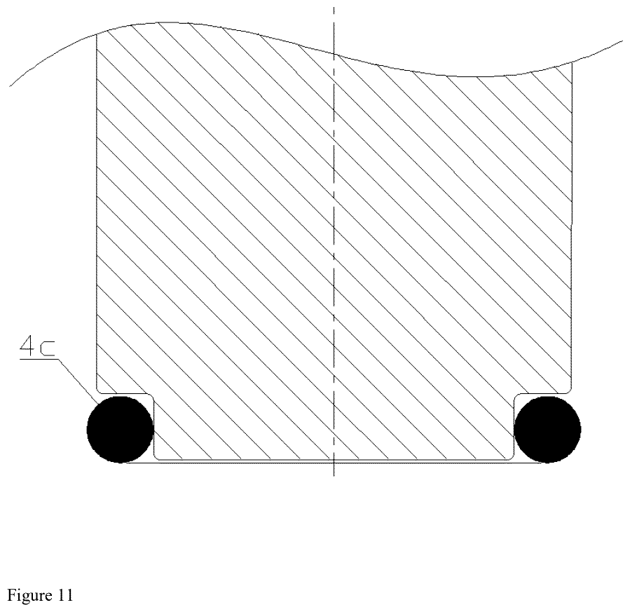

As shown in FIG. 11, as can be seen from the foregoing description, when a bit is inserted into the bit connecting hole 11, magnetically conductive structures exist on two sides of the magnet 3. In consideration of that magnetic field lines are symmetrically distributed on the two sides of the magnet 3. A dotted line A in FIG. 11 represents a symmetry center of the magnetic field lines generated by the magnet 3. Because the shaft end sleeve 1 located outside the magnet 3 is made of a non-magnetically conductive material, it may be considered that the shaft end sleeve 1 has no impact (or little impact) on a distribution of a magnetic field. In addition, because the magnetically conductive structures exist on the two sides of the magnet 3, most magnetic field lines are distributed in the magnetically conductive structures on the two sides. In addition, the magnetically conductive structures are “stretched” along an axis, i.e., magnetic field lines inside the magnetically conductive structures extend in an axial direction of the magnetically conductive structures. For details, refer to a size DI in FIG. 11. If a magnetically conductive structure is provided on neither of the two sides of the magnet 3, it may be considered that air exists on two sides of D1. Air has extremely low permeability, which can nearly be considered to be zero. In this state, the size D1 in FIG. 11 is relatively small.

To make the magnetic field lines emitted from two ends of the magnet 3 enter the magnetically conductive structures as much as possible and avoid a “magnetic leakage” phenomenon along an outer edge of the magnet 3, therefore, in this embodiment, a single-surface end surface area of the magnet 3 is not greater than an area of a shaft end of the power output shaft front section 2 in contact with the magnet 3. Generally, a cross-section of the power output shaft front section 2 is a regular polygon (during specific implementation, a regular polygon is mostly used), a radial cross-section of the magnet 3 is a circle, and an opposite-side size (a minimum radial size) of the regular polygon is not less than a diameter of the magnet 3.

To resolve the problem of controlling bit insertion and removal forces mentioned in the BACKGROUND, in this embodiment, a magnetic force adjustment structure is further disposed at a bit connecting end of the magnet 3, and the magnetic force adjustment structure is one of a gasket 4, a ring, or a combined structure of the gasket 4 and the ring.

When the magnetic force adjustment structure is a ring, the ring is a ring 4a with an inner bevel, a right-angle ring 4b or a ring 4c with a cross-section being a circle, and the inner bevel is in contact with a chamfer at a tail portion of a connected bit.

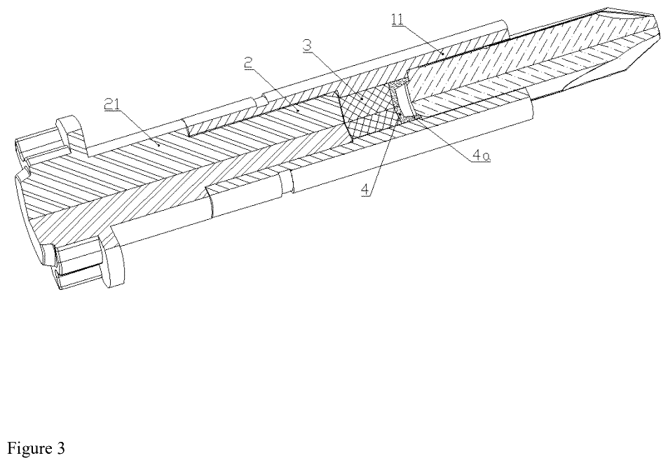

When the magnetic force adjustment structure 4 is a combined structure of the gasket and the ring, the gasket 4 and the ring have an integrated structure (FIG. 3) with equal outer diameters or a concentric stack structure (a split structure) of the gasket 4 and the ring with equal outer diameters, and the gasket 4 is placed between the magnet 3 and the ring.

When the magnetic force adjustment structure is a ring, the ring is a C-shaped ring 5 or a closed ring structure. When the magnetic force adjustment structure is a closed ring structure, the closed ring structure matches the chamfer at the tail portion of the bit, and the chamfer of the bit is one of an inclined-plane chamfer or a right-angled chamfer.

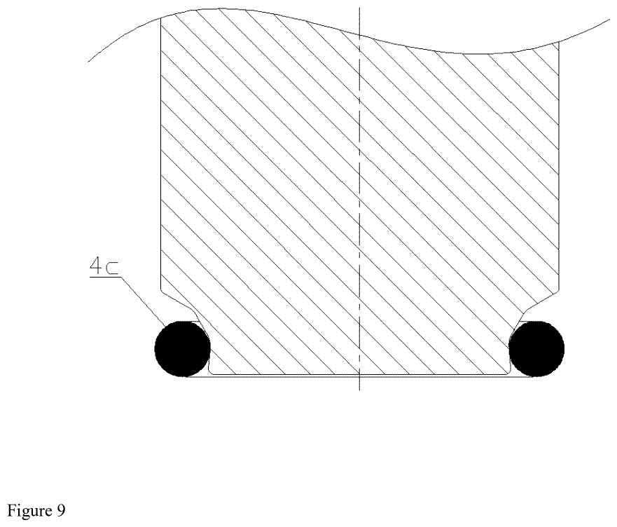

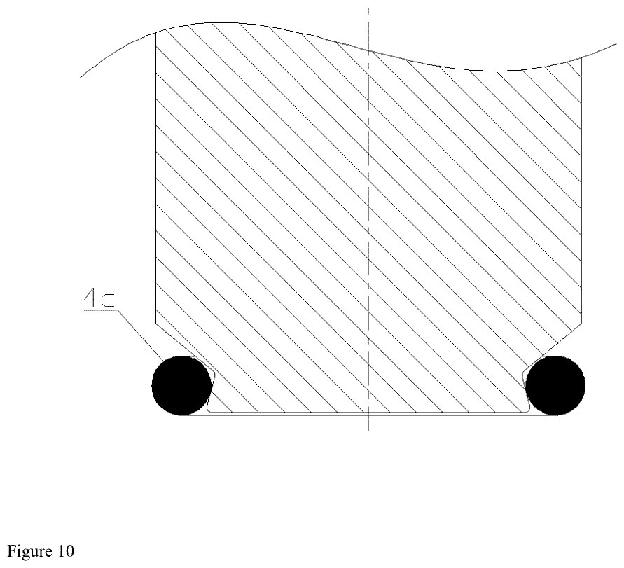

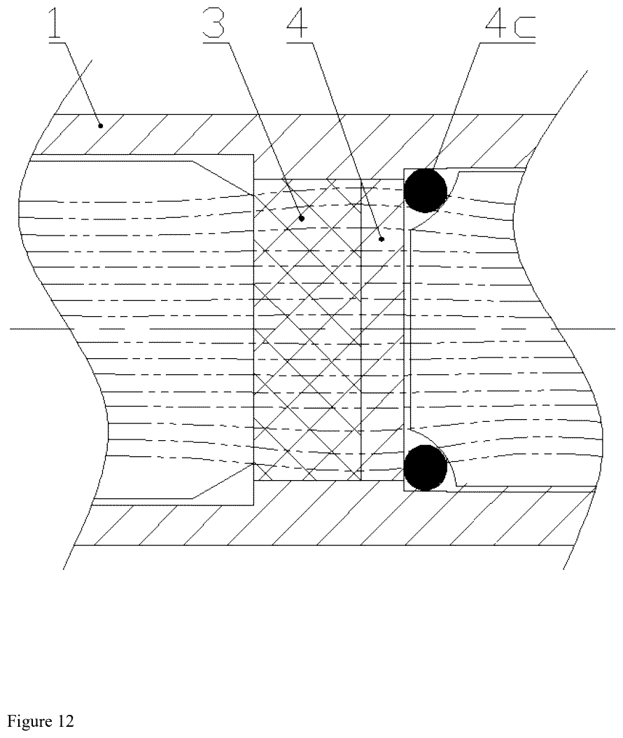

When the C-shaped ring 5 is used, an arc-shaped chamfer (FIG. 9), a trapezoidal chamfer (FIG. 11) or a right-angled chamfer (FIG. 10) matching the C-shaped ring 5 is disposed at a tail portion of a bit. The benefit of this design is that in one aspect, an attraction force between the bit and the magnet 3 can be increased through a mechanical locking force of the C-shaped ring 5, and moreover, the magnetic force adjustment structure is bonded between a periphery of the tail portion of the bit and the magnet 3, so that a magnetic flux cross-section between an outer edge of the tail portion of the bit and the magnet 3 is larger, thereby improving the magnetoconductivity between the two. Double-dot dash lines in FIG. 12 may represent the distribution of the foregoing magnetic field. It can be seen that when being a magnetically conductive structure, the magnetic force adjustment structure can connect the outer edge of the tail portion of the bit and the magnet 3, to avoid a “magnetic leakage” phenomenon at this position.

The shaft end sleeve 1 is connected to the C-shaped ring 5 by an inner annular groove 12. The inner annular groove 12 is configured for fastening an axial position of the C-shaped ring 5. Within a specific range, it may be allowed that the C-shaped ring 5 has a specific radial contraction capability.

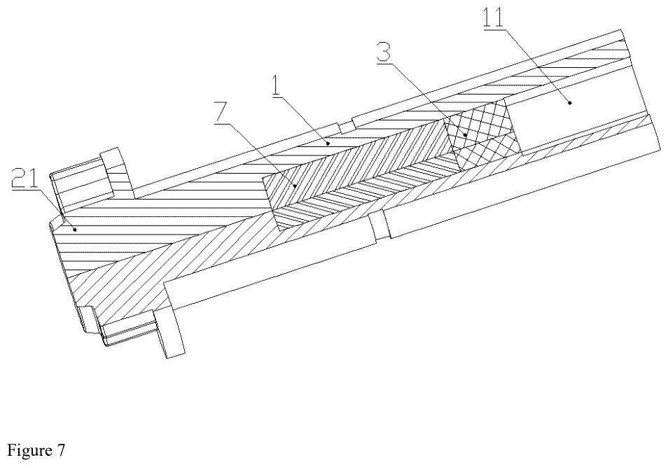

In this embodiment, the power output shaft front section 2 is transmission-connected to a motor body by a power output shaft rear section 21 and a speed change gearbox sequentially, and the power output shaft front section 2 and the power output shaft rear section 21 have a split structure or an integrated structure. As shown in FIG. 7, the power output shaft rear section 21 and the shaft end sleeve 1 have an integrated structure and a non-magnetically conductive structure, a magnetic guiding block 7 in contact with the magnet 3 is disposed in the integrated structure, and the magnetic guiding block 7 is made of a magnetically conductive material, and has the function of the power output shaft front section 2 in the magnetic field.

In some application scenarios, a connecting sheet 6 made of a magnetically conductive material is further disposed between the shaft end of the power output shaft front section 2 and the magnet 3.

This embodiment further discloses an electric screwdriver using the foregoing tool bit connection shaft structure for an electric screwdriver.

Compared with the prior art, in the present invention, a disadvantage that originally an output shaft end of an electric screwdriver is generally processed by using a magnetically conductive material being iron is changed, a manner of combining an outer sleeve made of a non-magnetically conductive material and an output shaft section made of a magnetically conductive material is used, and a magnetic guiding block (the magnetic guiding block and the output shaft section may be combined into one part) is disposed at a rear portion of a magnet, to increase a quantity of magnetic lines of force that converge at a tip portion at a distal end of a bit, thereby reducing magnetic leakage, and improving a magnetic force of the tip portion of the bit.

In the present invention, the magnetic force adjustment structure may be further added between the magnet and a tool bit, so that while it is ensured that a magnetic circuit is unimpeded and a magnetic force at a tip portion of a bit is sufficient, a direct attraction force of the magnet on a conventional ordinary tool bit, especially a tool bit with a small specification, is reduced to a degree that allows comfortable insertion and removal by a user.

An original internal structure of a shaft end is changed, and a spring structure for mechanical clamping is added based on an original function of magnetically attracting a bit, so that some tool bits that require more secure clamping, for example, a hex shank drill bit, can be fastened doubly.

The foregoing descriptions are merely preferred implementations of the present invention. A person of ordinary skill in the art may further make several improvements and variations without departing from the technical principle of the present invention, and the improvements and variations fall within the scope of protection of the present invention.

1. A tool bit connection shaft structure for an electric screwdriver, comprising a power output shaft front section (2) and a shaft end sleeve (1) in cooperation with the power output shaft front section (2), wherein a magnet (3) and a bit connecting hole (11) are provided in the shaft end sleeve (1), and the power output shaft front section (2), the magnet (3), and the bit connecting hole (11) are sequentially arranged in an axial direction of the shaft end sleeve (1); and
the shaft end sleeve (1) is made of a non-magnetically conductive material.

2. The tool bit connection shaft structure for an electric screwdriver according to claim 1, wherein the power output shaft front section (2) is made of a magnetically conductive material, and an end surface of the power output shaft front section (2) and the magnet (3) are in contact with each other.

3. The tool bit connection shaft structure for an electric screwdriver according to claim 2, wherein a single-surface end surface area of the magnet (3) is not greater than an area of a shaft end of the power output shaft front section (2) in contact with the magnet (3).

4. The tool bit connection shaft structure for an electric screwdriver according to claim 2, wherein a radial cross-section of the power output shaft front section (2) is a regular polygon, a radial cross-section of the magnet (3) is a circle, and an opposite-side size of the regular polygon is not less than a diameter of the magnet (3).

5. The tool bit connection shaft structure for an electric screwdriver according to 3, wherein a radial cross-section of the power output shaft front section (2) is a regular polygon, a radial cross-section of the magnet (3) is a circle, and an opposite-side size of the regular polygon is not less than a diameter of the magnet (3).

6. The tool bit connection shaft structure for an electric screwdriver according to claim 1, wherein a magnetic force adjustment structure is further disposed at a bit connecting end of the magnet (3), and the magnetic force adjustment structure is one of a gasket (4), a ring, or a combined structure of the gasket (4) and the ring.

7. The tool bit connection shaft structure for an electric screwdriver according to claim 6, wherein when the magnetic force adjustment structure is a ring, the ring is a ring (4a) with an inner bevel, a right-angle ring (4b) or a ring (4c) with a cross-section being a circle, and the inner bevel is in contact with a chamfer at a tail portion of a connected bit.

8. The tool bit connection shaft structure for an electric screwdriver according to claim 6, wherein when the magnetic force adjustment structure is a combined structure of the gasket (4) and the ring, the gasket (4) and the ring have an integrated structure with equal outer diameters or a concentric stack structure of the gasket (4) and the ring with equal outer diameters, and the gasket (4) is placed between the magnet (3) and the ring.

9. The tool bit connection shaft structure for an electric screwdriver according to claim 7, wherein when the magnetic force adjustment structure is a ring, the ring is a C-shaped ring (5) or a closed ring structure.

10. The tool bit connection shaft structure for an electric screwdriver according to claim 9, wherein when the magnetic force adjustment structure is a closed ring structure, the closed ring structure matches the chamfer at the tail portion of the bit, and the chamfer of the bit is one of an inclined-plane chamfer or a right-angled chamfer.

11. The tool bit connection shaft structure for an electric screwdriver according to claim 1, wherein a C-shaped ring (5) is further disposed at a bit connecting end of the magnet (3), and an arc-shaped chamfer, a trapezoidal chamfer or a right-angled chamfer matching the C-shaped ring (5) is disposed at a tail portion of a bit.

12. The tool bit connection shaft structure for an electric screwdriver according to claim 1, wherein the power output shaft front section (2) is transmission-connected to a motor body by a power output shaft rear section (21) and a speed change gearbox sequentially, and the power output shaft front section (2) and the power output shaft rear section (21) have a split structure or an integrated structure.

13. The tool bit connection shaft structure for an electric screwdriver according to claim 1, wherein a connecting sheet (6) made of a magnetically conductive material is further disposed between the shaft end of the power output shaft front section (2) and the magnet (3).

14. The tool bit connection shaft structure for an electric screwdriver according to claim 11, wherein the shaft end sleeve (1) is connected to the C-shaped ring (5) by an inner annular groove (12).

15. The tool bit connection shaft structure for an electric screwdriver according to claim 1, wherein a power output shaft rear section (21) and the shaft end sleeve (1) have an integrated structure and a non-magnetically conductive structure, a magnetic guiding block (7) in contact with the magnet (3) is disposed in the integrated structure, and the magnetic guiding block (7) is made of a magnetically conductive material.

16. An electric screwdriver, comprising the tool bit connection shaft structure for an electric screwdriver according to claim 1.
